(19) United States
(12) Patent Application Publication
(10) Pub. No.: US 2013/0129863 A1
(43) Pub. Date: May 23, 2013

(54) Lactic Acid-Fermented Egg Having Reduced Egg Protein Antigenicity Through Addition Of Sodium Citrate, Heating Treatment, And Lactic Acid Fermentation, And Method For Preparing Same

(71) Applicant: Ickjong Yoo, Songnam (KR)

(72) Inventor: Ickjong Yoo, Songnam (KR)

(21) Appl. No.: 13/580,988

(22) PCT Filed: Mar. 24, 2011
(86) PCT No.: PCT/KR2011/002043

§ 371 Date: Aug. 24, 2012

(30) Foreign Application Priority Data
Aug. 11, 2010 (KR) 10-2010-0077587

(51) Int. Cl. A23L 1/32

(52) U.S. Cl. CPC A23L 1/3208
USPC 426/47; 426/614

(57) ABSTRACT

The present invention relates to a lactic acid-fermented egg having reduced egg protein antigenicity and improved organoleptic quality through the addition of sodium citrate, heating treatment, and lactic acid bacteria fermentation, and more specifically, to a lactic acid-fermented egg having reduced egg protein antigenicity, which comprises a series of steps of adding to whole egg liquid a fixed amount of filtered water, sugar, and sodium citrate, heating treating and lactic acid-fermenting same, and a method for preparing same. The present invention reduces the antigenicity of ovomucoid and ovalbumin, which are allergy inducing factors existing inside an egg, has excellent solubility, and excellent organoleptic quality.

### TECHNICAL FIELD

The present invention relates to a method for preparing a lactic acid-fermented egg having reduced egg protein antigenicity and improved organoleptic quality through the addition of sodium citrate, heating treatment, and lactic acid bacteria fermentation.

### BACKGROUND ART

A food allergy means that immune system overreacts to a specific material in dietary foods that came into our bodies and cause various symptoms, and shows various cases of diseases, including general symptoms such as asthma, itchy rash, fever, and the like, neurological symptoms represented by allergic tension relaxation syndrome, digestive troubles including diarrhea, stomachache, emesis, and the like.

Not many people have food allergies, but in severe cases, even lives of people who have food allergies may be threatened by allergic foods. 150 million people worldwide (6 to 7 million people in the U.S., 2.5% of the population in developing countries, 5 to 38% of the population in South Korea) suffer from food allergy.

Food allergens are mainly the proteins in foods, and in the U.S., eight kinds of foods, such as cow milk, eggs, soybean, fish, and so on, that are eaten in everyday use, are known to occupy 90% or more of total allergic reactions. In a study of the most common allergic foods in South Korea, in order to assess allergic foods in Korea, Dae-Yeul Son et al. [Korean Journal of Food Science and Biotechnology. 34(5): 885-888(2002)] undertook a total 9054 allergic tests on 1707 people during about three years. Positive results were 11.3%, consisting of 336 on egg white, 266 on cow milk, 95 on egg yolk, 76 on soybean, 69 on alpha-lactalbumin, 61 on casein, 58 on beta-lactoglobulin, 39 on buckwheat, 12 on wheat, 3 on beef, 2 on crab, and 1 on rice, shrimp, pork, chicken, and mackerel.

Among food allergies, egg allergy is one of the most frequent, representative food allergies in young children, and unlike cow milk allergy, it is also found in adults. For research on egg allergens which cause the egg allergy, biochemical interpretations have been developing, and it is known that major egg allergens are present in egg white that occupies 60% or more of the total egg weight, and egg yolk proteins have very low relevance with allergy. More than 20 kinds of egg white proteins are known. Among them, representative egg white proteins are ovalbumin, ovomucoid, and lysozyme. Ovalbumin (OA; allergen name, Gal d 2) occupies 54% of the total egg white proteins, and is considered to be the main allergen. However, from the fact that in a case that egg allergy patient's blood has an IgE antibody specific to egg white proteins, but has no IgE antibody specific to ovomucoid(OM; allergen name, Gal d 1), when the patient eats the egg white, allergy is not caused, ovomucoid is considered to be the most important allergen.

Ovomucoid occupies about 11% of the total egg white proteins, and is composed of three subunits, each of which has three S—S bonds in a molecule, and the higher order structure is not easily destroyed by heat or chemical treatments. Since ovomucoid has a protease inhibitor activity, and thus, exhibits very strong resistance to digestive enzymes, it is considered that ovomucoid shows higher allergenicity than ovalbumin. Considering that egg allergy is common in infants who have an immature immune system in the intestinal tract and weak ability to secrete digestive enzymes, and becomes cured with age due to maturation of the intestinal tract, it is a persuasive contention that highly digestion-resistant ovomucoid is in fact the main allergen.

In the report on treatment and prevention of food allergy, Seungyeon Nam and Sangil Lee [Food Science and Industry. 33(4): 16-21(2000)] found that when breastfeeding women were on an allergenic food restricted diet as the first preventive method, allergic skin lesions were decreased during infancy, and suggested that women should breastfeed their babies, but avoid peanuts, nuts, fishes and shellfishes during breastfeeding, and abstain from cow milk and eggs, as the case may be.

So, though egg is called as a complete food and is a highly nutritious food, it becomes a food group that should be avoided not only in infants but also in breastfeeding mothers.

As research results for solving the above problems, Korean Patent Application Publication No. 2009-0079128 discloses a method for preparing eggs having reduced antigenicity of ovomucoid and ovalbumin by adding water, glucose, fructose, and fructooligosaccharide to an egg (whole egg liquid), homogenizing the egg mixture, heating and sterilizing, and fermenting with lactic acid bacteria, and a method for preparing eggs having reduced antigenicity of phosvitin and livetin by adding water, glucose, fructose, and fructooligosaccharide to egg yolk liquid, homogenizing the mixture, heating and sterilizing at 75 to 100° C., and performing lactic acid fermentation. In addition, Ju-Hyune Ryu et al. disclosed that enzyme treatment could reduce antigenicity of ovalbumin, but heat treatment at 121° C. reduced antigenicity of ovomucoid, whereas it rather increased antigenicity of ovalbumin in Korean Journal of Food Science and Biotechnology, 36(1): 147-151(2004). While it is not a research for reducing egg allergy, regarding a process for preparing lactic acid-fermented eggs by using eggs to induce lactic acid fermentation, a method for preparing egg lactic acid bacteria fermented beverages by adding 1 to 10% of lactose, 2 to 20% of sucrose, and 100 to 1000% of water to an egg, heating and sterilizing at 65 to 95° C. for 10 to 120 minutes, inoculating with 0.001 to 2% of a mixed lactic acid bacteria (1:2:1=Lactobacillus, Bifidobacterium, Streptococcus), and incubating and fermenting at 30 to 50° C. for 5 to 24 hours was disclosed in Korean Patent No. 10-0115910, but objects, processes, and effects are distinguishable from the present invention and there is an obvious difference.

Meanwhile, it is known that antigenicity of allergy-causing proteins are weaken or removed in fermented dairy products. In a research on assessment of allergenicity of fermented dairy products by immunoassay, to determine betalactoglobulin (BLG), the milk allergen present in market milk, powdered milk, and fermented milk, Kun-Og Kang [The Korean Journal of Food and nutrition. 19(3): 296-300 (2006)] used immunoblotting and competitive indirect enzyme-linked immunosorbent assay (ciELISA). In immunoblotting, the reaction with milk allergy patients' IgE was not shown in fermented milk, but it was shown in both powered milk and market milk. The BLG content was measured with polyclonal antibody and milk allergy patients' IgE, and the results indicated that the market milk had the highest BLG content and the fermented milk had the lowest BLG content. As part of an effort to remove the remaining antigenicity also in the fermented milk, Korean Patent Application Publication No. 2007-0071535 discloses a method for preparing fermented milk with reduced antigenicity and no bitterness by adding a fixed amount of proteinases to milk proteins and fermenting.

However, the above described prior arts cannot reduce antigenicity of both ovomucoid and ovalbumin, which are known as main egg allergens, at the same time, and since heat treatment temperature is excessively high, solubility may be lowered due to protein thermal denaturation and it is difficult to ensure excellent organoleptic characteristics. Or, in case heat treatment temperature is low, there is a problem in that proliferation of lactic acid bacteria is not in the push and organoleptic characteristic is also poor. In addition, unlike cow milk, egg products of which allergy components are reduced or removed have been not yet available in the market.

### DISCLOSURE

### Technical Problem

The present inventor has studied and tried to solve the above problems and found that a lactic acid-fermented egg having reduced egg protein antigenicity, excellent organoleptic quality, and excellent solubility could be produced through the addition of fixed amounts of sugars, water, and salts to an egg, heating treatment under a certain temperature condition, inoculation with mixed lactic acid bacteria starter and lactic acid-fermentation under an appropriate temperature condition, thereby leading to completion of the present invention.

Therefore, an object of the present invention is to provide a lactic acid-fermented egg having reduced antigenicity of egg white proteins, the major allergens of egg proteins, especially, ovomucoid and ovalbumin, at the same time, and improved organoleptic quality, and a method for preparing thereof.

### Technical Solution

In accordance with an exemplary embodiment, a method for preparing a lactic acid-fermented egg having reduced protein antigenicity of the present invention, comprises adding and mixing 100 to 200 parts by weight of purified water, 25 to 35 parts by weight of sugars, and 0.4 to 0.5 parts by weight of sodium citrate, with respect to 100 parts by weight of homogenized and filtered whole egg liquid; heat-treating the above mixture at a temperature between 72 and 83° C. for 10 to 20 minutes; and inoculating with 0.0001 to 0.01 weight % of lactic acid bacteria on the basis of a weight of the mixture and fermenting the inoculated mixture at a temperature between 38 and 42° C. for 5 to 7 hours in order to achieve the above described object.

In accordance with another exemplary embodiment, the present invention comprises a lactic acid-fermented egg prepared by the above method, the lactic acid-fermented egg having reduced protein antigenicity, excellent solubility, and improved flavor.

Hereinafter, the present invention will be described in detail to focus on the method for preparing a lactic acid-fermented egg in each step.

The first step is adding and mixing purified water, sugars, and sodium citrate to whole egg liquid, namely adding purified water and sugars, and more particularly, adding and mixing purified water, sugars, and sodium citrate, to whole egg liquid prepared by homogenizing and filtering whole eggs to remove the chalazae.

The purified water is added in order to inhibit egg protein thermal coagulation caused by heat treatment and may be used in a range from 100 to 200 parts by weight, with respect to 100 parts by weight of whole egg liquid.

The addition of sugars can elevate a thermal coagulation temperature of proteins caused by heat treatment and thus inhibit the deterioration of solubility caused by thermal coagulation and the like, and a mixture of glucose, fructose, and fructooligosaccharide may be used for the sugars. The sugars may be used in a range from 25 to 35 parts by weight, with respect to 100 parts by weight of whole egg liquid, and particularly, a sugar mixture comprising 5 to 8 parts by weight of glucose, 15 to 20 parts by weight of fructose, and 5 to 7 parts by weight of fructooligosaccharide may be used.

One technical feature of the present invention is the addition of sodium citrate as a salt, in addition to the above described purified water and sugars. This use of salts has not been done in existing research on inhibition of egg allergy, and there was no example of addition of salts to prepare a lactic acid-fermented egg. In addition, in the present invention, with the use of sodium citrate, even a low heat treatment temperature contributed highly to lactic acid bacteria growth during lactic acid fermentation, and thus, products having high content of lactic acid bacteria could be prepared, and antigenicity could be reduced, and the flavor of products could be significantly improved.

Sodium citrate may be used in a range from 0.4 to 0.5 parts by weight with respect to 100 parts by weight of whole egg liquid to accomplish the pursuit of the invention.

The second step is heat-treating the mixture.

Heat-treating the egg mixture is a pretreatment for the next step of lactic acid fermentation, and sterilization of bacteria that exhibit inhibitory effect on lactic acid fermentation or are undesirable for flavors and health, including salmonella, which might be comprised in the egg, can be done by heat-treating.

In the present invention, heat-treating is carried out in a range from 72 to 83° C. Where a heat treatment temperature is lower than the range, the germicidal effect tends to be insufficient, and where a heat treatment temperature is higher than the range, coagulation caused by thermal denaturation of egg proteins leads to the reduction in solubility, and therefore, applicability toward second products tends to be lowered and flavors are not desirable.

The third step is lactic acid-fermenting the heat-treated egg mixture.

The egg mixture sterilized by heat-treating is inoculated with lactic acid bacteria and fermented, and the inoculation amount may be 0.0001 to 0.01 weight % on the basis of a weight of the egg mixture. A mixed lactic acid bacteria starter comprising Lactobacillus acidophilus, Lactobacillus bulgaricus, Bifidobacterium longum, and Streptococcus thermophiles may be used for the lactic acid bacteria, and the mixing ratio may be 20 to 30 weight % of Lactobacillus acidophilus, 20 to 30 weight % of Lactobacillus bulgaricus, 20 to 30 weight % of Bifidobacterium longum, and 20 to 30 weight % of Streptococcus thermophiles. After inoculation with the lactic acid bacteria, the egg mixture is fermented at 38 to 42° C. for 5 to 7 hours.

The lactic acid-fermented egg prepared by the above method has significantly reduced antigenicity of both ovomucoid and ovalbumin, which are considered to be the main allergens in egg, improved flavors, and a lot of lactic acid bacteria.

According to the present invention as described above, the lactic acid-fermented egg, with significantly reduced or removed antigenicity of ovomucoid and ovalbumin, the representative allergy-inducing egg white proteins in egg can be obtained by adding fixed amounts of purified water and sugars to an egg, adding a fixed amount of sodium citrate to the egg, heat-treating the mixture, and lactic acid-fermenting. It is expected to be appreciated that the present invention provides a future opportunity to intake eggs without concern for allergy for many infants and general consumers who consider eggs as the allergy-inducing food and avoid eating eggs

### Advantageous Effects

According to the present invention as described above, the lactic acid-fermented egg having significantly reduced antigenicity of both ovomucoid and ovalbumin, wherein the existing known antigenicity of egg white is weakened by heat-treatment, addition of sugars and salts, lactic acid fermentation, etc., can be prepared by a simple method.

Also, according to the present invention as described above, the lactic acid-fermented egg, which cannot only rule out egg allergy, but also provide an opportunity to take large amounts of lactic acid bacteria through lactic acid fermentation, can be provided.

Further, according to the present invention as described above, it is possible to remove the allergy-inducing characteristic and provide lactic acid bacteria at the same time, and thus, the added value of eggs can be improved, and effects which may contribute to related industries can be expected.

Still further, according to the present invention, there is an advantage of providing egg products for infants and children with allergy concerns as well as adults.

### BEST MODE

Hereinafter, the present invention will be described in detail in accordance with embodiments and the like, however, the present invention is not limited to the following embodiments and the like.

### <Reference Embodiment> Materials for Experiments

“Eggs laid by healthy hens raised on herbage™” manufactured by Pulmuone was used for eggs in the present invention. Glucose, fructose, and fructooligosaccharide were purchased from Samyang Genex Corp. to use. The lactic acid starter was imported through domestic S company to use. Standard preparations of ovomucoid (OM) and ovalbumin (OA) were obtained from Sigma (St. Louis, USA), and other reagents were used in accordance with Ju-hyune Ryu et al [Korean Journal of Food Science and Biotechnology. 32: 720-725(2000)].

### Embodiment 1

20 eggs (size: extra large) were broken open and homogenized so as not to form too much foam, and were filtered through a 70 mesh sieve to obtain 1,000 g of chalazae removed, whole egg liquid. Egg mixture in which 1,700 g of purified water, 60 g of glucose, 180 g of fructose, 55.2 g of fructooligosaccharide, and 4.5 g of sodium citrate were added to the whole egg liquid were prepared, heat-treated at 75° C. for 15 minutes, and were cooled immediately to 40° C. The egg mixture was inoculated with 0.3 g, that is, 0.01 weight % of a mixed lactic acid bacteria starter on the basis of a weight of the egg mixture, and the mixed lactic acid bacteria starter comprised 25% of Lactobacillus acidophilus, 25% of Lactobacillus bulgaricus, 25% of Bifidobacterium longum, and 25% of Streptococcus thermophilus. The egg mixture was incubated in a pyrostat at 40° C. for 6 hours for lactic acid fermentation, and was cooled immediately to be 4° C. or lower to prepare 3,000 g of lactic acid-fermented eggs having significantly reduced egg protein antigenicity.

Parenthetically, ciELISA test results showed that the antigenicity of ovomucoid (OM) of such produced lactic acid-fermented eggs was reduced to 1/52,500 or less, and the antigenicity of ovalbumin (OV) was reduced to 1/7,400 or less, compared to fresh eggs.

### Embodiment 2

20 eggs (size: extra large) were broken open and homogenized so as not to form too much foam, and were filtered through a 70 mesh sieve to obtain 1,000 g of chalazae removed, whole egg liquid. Egg mixture in which 1,700 g of purified water, g of glucose, 180 g of fructose, 55.2 g of fructooligosaccharide, and 4.5 g of sodium citrate were added to the whole egg liquid were prepared, heat-treated at 80° C. for 15 minutes, and were cooled immediately to 40° C. The egg mixture was inoculated with 0.3 g, that is, 0.01 weight % of a mixed lactic acid bacteria starter on the basis of a weight of the egg mixture, and the mixed lactic acid bacteria starter comprised 25% of Lactobacillus acidophilus, 25% of Lactobacillus bulgaricus, 25% of Bifidobacterium longum, and 25% of Streptococcus thermophilus. The egg mixture was incubated in a pyrostat at 40° C. for 6 hours for lactic acid fermentation, and was cooled immediately to be 4° C. or lower to prepare 3,000 g of lactic acid-fermented eggs having significantly reduced egg protein antigenicity.

Parenthetically, ciELISA test results showed that the antigenicity of ovomucoid (OM) of such produced lactic acid-fermented eggs was reduced to 1/150,000 or less, and the antigenicity of ovalbumin (OV) was reduced to 1/10,000 or less, compared to fresh eggs.

### Comparative Embodiment 1

1,700 g of purified water, 60 g of glucose, 180 g of fructose, 55.2 g of fructooligosaccharide, and 4.5 g of sodium citrate were added to 1,000 g of whole egg liquid prepared by breaking open and homogenizing eggs, and removing chalazae. The egg mixture was heat-treated at each temperature condition for 15 minutes and cooled to 40° C., and was inoculated with 0.3 g, that is, 0.01 weight % of a mixed lactic acid bacteria starter on the basis of a weight of the egg mixture, and the mixed lactic acid bacteria starter comprised 25% of Lactobacillus acidophilus, 25% of Lactobacillus bulgaricus, 25% of Bifidobacterium longum, and 25% of Streptococcus thermophiles. The egg mixture was incubated at 40° C. for 6 hours for completing lactic acid fermentation, and was immediately cooled and kept under a condition at 4° C. or lower. Changes in the antigenicity of OM and OA were examined using ciELISA.

### Comparative Embodiment 2

The same eggs were used as in <Embodiment 1>. However, egg mixtures, in which 0.45 g of sodium citrate, that is, 0.45 parts by weight of sodium citrate on the basis of a weight of eggs, was included, and to which both heat treatment and lactic acid fermentation were not conducted, were prepared to use in each comparative experiment.

### Comparative Embodiment 3

The same eggs (fresh eggs) as in <Embodiment 1> were used in each comparative experiment.

### Experimental Embodiment

1. Heat-Treatment and Lactic Acid Fermentation of Eggs

Whole egg liquid was obtained from eggs, homogenized, and was filtered through a 70 mesh sieve to remove chalazae. Then, an egg mixture prepared by comprising purified water, glucose, fructose, and fructooligosaccharide the same as in <Embodiment 1>, and adding [Embodiment 1] or not adding [Comparative embodiment 1] the same amount of sodium citrate as in <Embodiment 1> was heat-treated at each temperature (65 to 100° C. for 15 minutes and cooled to 40° C., and was inoculated with 0.01 weight % of a mixed lactic acid bacteria starter comprising 25% of Lactobacillus acidophilus, 25% of Lactobacillus bulgaricus, 25% of Bifidobacterium longum, and 25% of Streptococcus thermophiles, on the basis of a weight of the egg mixture. The egg mixture was incubated at 40° C. for 6 hours for completing lactic acid fermentation, and was immediately cooled and kept under a condition at 4° C. or lower, and was used for testing.

Meanwhile, an egg mixture [Comparative embodiment2] was prepared by adding 0.45 g of sodium citrate, that is, the same weight ratio, 0.45 parts by weight of sodium citrate on the basis of a weight of an egg, to the same egg as used in <Embodiment 1> and not performing heat-treatment and lactic acid bacteria fermentation, and was used for each comparative experiment. Eggs (fresh eggs) which were as used in <Embodiment 1> were prepared for each comparative experiment.

2. Production of Specific Antibodies Against Ovalbumin (OA) and Ovomucoid (OM)

1 mg/mL of OA or OM in phosphate buffered saline (PBS: 0.01M phosphate buffer with 0.138M NaCl, 0.0027M KCl) as an antigen was mixed with Freund's complete adjuvant at a ratio of 1:1 to make an emulsion. Each time, 1 mL of the emulsion was injected hypodermically to a rabbit. Immunization was done at fortnightly intervals, up to five times. But, Freund's incomplete adjuvant was used as an adjuvant from the second immunization. One week after immunizations, blood was collected and antiserum with high antibody titer was collected to use as a specific antibody in subsequent experiment.

3. Competitive Indirect ELISA (ciELISA)

Antigen reaction was investigated using ciELISA. Standard protein OM or OA were used as an antigen coated on a microplate, and the concentration was 2 μg/mL. Standard protein OM or OA were diluted with a coating buffer (tris hydroxymethyl aminomethane 0.05M, pH 9.0), and 100 μL of OM or OA were dispensed into the microplate wells and the plates were maintained overnight at 4° C. After washing the plates with a washing buffer (phosphate buffered saline with Tween 20, PBST; 0.01M phosphate buffer with 0.138M NaCl, 0.0027M KCl, 0.05% Tween 20) three times, 100 μL of a solution in which fresh eggs or the above prepared lactic acid-fermented eggs and specific antibodies were mixed at a ratio of 1:1 was added into each well to induce competitive reaction.

The above prepared anti-OM antiserum and anti-OA antiserum were diluted about 5,000 times and used for the specific antibodies. After reaction for 1 hour at room temperature, the plates were washed with a washing buffer three times, and 100 μL of goat anti-rabbit IgG-HRP conjugate was added to each well and allowed to react for 1 hour at room temperature. After reaction, the plates were washed by the above method three times, and 100 μL of substrate solution (0.01% TMB in phosphate-citrate buffer pH 5.0, 0.001% H₂O₂) was added into each well and allowed to react for 30 minutes. The reaction was halted via the addition of 50 μL of 2M H₂SO₄. Absorbance at 450 nm was measured using a microplate reader (Emax, Molecular Devices).

Antigenicity changes of fresh eggs and lactic acid-fermented eggs against standard proteins OM and OA depending on heat treatment conditions were evaluated as IC50 values from the above competitive indirect ELISA test, and the results were shown in Table 1 and Table 2.

4. Investigation of Antigenicity

To examine antigenicity changes of the above prepared lactic acid-fermented eggs, IC50 (The half maximal inhibitory concentration) values of eggs before and after treatment were obtained from the results of the above ciELISA, and then, antigenicity changes were evaluated as relative figures obtained by dividing the former by the latter.

TABLE 1

| | Heat | | |
|---|---|---|---|
| | treatment | IC50 value of | |
| | temperature | different type of antigens | |
| Item | (° C.)* | Antigen OM | Antigen OA |
| Fresh eggs | — | 3 μg/mL | 30 μg/mL |
| (Comparative | | | |
| embodiment 3) | | | |
| Lactic acid- | 65 | 5 μg/mL | 40 μg/mL |
| fermented | 70 | 6 μg/mL | 50 μg/mL |
| eggs | 75 | 10 μg/mL | 70 μg/mL |
| (Comparative | 80 | 380,000 μg/mL | 50 μg/mL |
| embodiment 1) | 85 | 500,000 μg/mL | 420,000 μg/mL |
| | 90 | 1,800,000 μg/mL | 2,500,000 μg/mL |
| | 95 | 10,000,000 μg/mL | 12,000,000 μg/mL |
| | 100 | 15,000,000 μg/mL | 18,000,000 μg/mL |

*heating time: 15 minutes

The above Table 1 shows the result of testing antigenicity changes of fresh eggs and lactic acid-fermented eggs against standard proteins OM and OA depending on heat treatment conditions, which were evaluated with IC50 values from competitive indirect ELISA test. In the ciELISA using an anti-OM antibody, IC50 of fresh eggs [Comparative embodiment 3] was 3 μg/mL, and IC50 of lactic acid-fermented eggs, which were sterilized at different heat treatment conditions and lactic acid fermented, was 10 μg/mL, not a big change, up to 75° C., but, at temperatures of 80° C. or higher, that was significantly increased by 380,000 μg/mL to 15,000,000 μg/mL.

That is, antigenicity was reduced by 1/126,000 to 1/5,000,000 or less.

In the ciELISA using an anti-OA antibody, IC50 of fresh eggs was 30 μg/mL, and IC50 of lactic acid-fermented eggs was 50 μg/mL, not a big change, up to 80° C., but, at temperatures of 85° C. or higher, that was significantly increased by 420,000 μg/mL to 18,000,000 μg/mL.

That is, antigenicity was reduced by 1/14,000 to 1/600,000 or less.

TABLE 2

| | Heat | IC50 value of | |
|---|---|---|---|
| | treatment | different type of antigens | |
| Item | temperature* | Antigen OM | Antigen OA |
| Fresh eggs | — | 8 μg/mL | 50 μg/mL |
| (Comparative | | | |
| embodiment 2) | | | |
| Lactic acid- | 65 | 20 μg/mL | 80 μg/mL |
| fermented eggs | 70 | 250,000 μg/mL | 90 μg/mL |
| (Comparative | 75 | 420,000 μg/mL | 370,000 μg/mL |
| embodiment 1) | 80 | 1,200,000 μg/mL | 500,000 μg/mL |
| | 85 | 2,000,000 μg/mL | 1,300,000 μg/mL |
| | 90 | 3,500,000 μg/mL | 3,000,000 μg/mL |
| | 95 | 12,000,000 μg/mL | 15,000,000 μg/mL |
| | 100 | 16,000,000 μg/mL | 17,000,000 μg/mL |

*heating time: 15 minutes

The above Table 2 shows the result of testing antigenicity changes of fresh eggs (Comparative embodiment 2), to which the same parts by weight of sodium citrate was added, and lactic acid-fermented eggs prepared in the composition in Embodiment 1, against standard proteins OM and OA depending on heat treatment conditions, which were evaluated with IC50 values from competitive indirect ELISA test. In the ciELISA using an anti-OM antibody, IC50 of fresh eggs was 8 μg/mL, and IC50 of lactic acid-fermented eggs, which were sterilized at different heat treatment conditions and lactic acid fermented, was 20 μg/mL, not a big change, up to 65° C., but, at temperatures of 70° C. or higher, that was significantly increased by 250,000 μg/mL to 16,000,000 μg/mL.

That is, antigenicity was reduced by 1/31,250 to 1/2,000,000 or less.

In the ciELISA using an anti-OA antibody, IC50 of fresh eggs was 50 μg/mL, and IC50 of lactic acid-fermented eggs was 90 μg/mL, not a big change, up to 70° C., but, at temperatures of 75° C. or higher, that was significantly increased by 370,000 μg/mL to 17,000,000 μg/mL.

That is, antigenicity was reduced by 1/7,400 to 1/340,000 or less.

When put together, results of Table 1 and Table 2 showed that antigenicity of heat-treated lactic acid-fermented eggs was significantly lower than that of fresh eggs, and with the addition of sodium citrate, antigenicity of lactic acid-fermented eggs was reduced even at low heat treatment temperatures. That is, it was found that a condition for reducing antigenicity of both ovomucoid and ovalbumin would require a heat treatment at 85° C/15 minutes or more, and with the addition of sodium citrate, the condition for reducing antigenicity of both ovomucoid and ovalbumin would require a heat treatment at 75° C/15 minutes or more.

5. Measurement of Solubility

Lactic acid-fermented eggs prepared in <Embodiment 1> and <Comparative embodiment 1> were diluted 10-fold with distilled water, homogenized for 3 minutes, allowed to stand still at room temperature for 30 minutes, and were centrifuged at 2, 000×g for 20 minutes to remove insoluble proteins. Protein content in the supernatant was measured and expressed as a percentage on the basis of total protein content in sample. The result was shown in the following Table 3.

TABLE 3

| | Solubility (%) of lactic acid-fermented eggs at different | | | | | | | |
|---|---|---|---|---|---|---|---|---|
| | heat treatment temperatures (heating time: 15 minutes) | | | | | | | |
| Item | 65° C. | 70° C. | 75° C. | 80° C. | 85° C. | 90° C. | 95° C. | 100° C. |
| Comparative | 98 | 97 | 93 | 95 | 75 | 72 | 68 | 60 |
| Embodiment 1 | | | | | | | | |
| Embodiment 1 | 96 | 94 | 94 | 95 | 78 | 73 | 70 | 65 |

The above Table 3 shows the result of testing changes in solubility of egg proteins of lactic acid-fermented eggs depending on heat treatment conditions and whether sodium citrate was added or not. Regardless of whether sodium citrate was added or not, lactic acid-fermented eggs with solubility of 90% or higher were heat-treated at a temperature of 80° C. or lower, and with heat-treatment at a temperature of 85° C. or higher, solubility was decreased and precipitation occurred.

6. Measurement of the Number of Lactic Acid Bacteria

Lactic acid-fermented eggs prepared in <Embodiment 1> and <Comparative embodiment 1> were diluted 10-fold with sterile 0.1% peptone water to use as test liquid. After incubation at 35 to 37° C. for 72 hours using plate count agar with BCP, 30 to 300 yellow colonies were counted as colonies of lactic acid bacteria, and the number of lactic acid bacteria (cfu/mL) was expressed by multiplying the average number of colonies by the dilution rate. The measurement result was shown in the following Table 4.

7. Measurement of Sample pH

pHs of lactic acid-fermented eggs prepared in <Embodiment 1> and <Comparative embodiment 1> were measured using a pH meter (Model 520A, Orion, U.S.A.) and the measurement result was shown in the following Table 4.

TABLE 4

| Heat | | | | |
|---|---|---|---|---|
| treatment | Number of lactic acid | | | |
| tempera- | bacteria (cfu/mL) | | pH | |
| ture | Embodiment | Comparative | Embodiment | Comparative |
| (° C.) | 1 | embodiment 1 | 1 | embodiment 1 |
| 65 | 3.4 × 10⁵ | 5.5 × 10⁵ | 4.9 | 5.0 |
| 70 | 6.1 × 10⁶ | 3.8 × 10⁶ | 4.8 | 4.9 |
| 75 | 3.5 × 10⁸ | 2.5 × 10⁷ | 4.3 | 4.5 |
| 80 | 4.7 × 10⁸ | 6.4 × 10⁷ | 4.3 | 4.4 |
| 85 | 7.5 × 10⁷ | 4.2 × 10⁶ | 4.5 | 4.8 |
| 90 | 2.8 × 10⁷ | 5.8 × 10⁶ | 4.6 | 4.9 |
| 95 | 7.4 × 10⁷ | 8.3 × 10⁵ | 4.6 | 5.1 |
| 100 | 5.6 × 10⁶ | 6.6 × 10⁵ | 5.0 | 5.2 |

Heating time: 15 minutes

The above Table 4 shows results of testing the number of lactic acid bacteria and changes in pH of lactic acid-fermented eggs depending on heat treatment conditions and whether sodium citrate was added or not. When eggs were heat-treated at a temperature of 75° C. or lower, the number of lactic acid bacteria in Embodiment 1, to which sodium citrate was added, was higher than that in Comparative embodiment 1, to which sodium citrate was not added. Likewise, pH of Embodiment 1, to which sodium citrate was added, was lower than pH of Comparative embodiment 1, to which sodium citrate was not added. Thus, it was considered that sodium citrate had a positive effect on the growth of lactic acid bacteria.

8. Organoleptic Testing Method

To objectively evaluate taste, color, texture, aroma, and total preference of lactic acid-fermented eggs prepared in <Embodiment 1> and <Comparative embodiment 1>, 15 trained inspectors examined samples using a nine-point scoring method according to an evaluation basis of [Very good:9, Good:7, Average:5, Poor:3, Very poor:1], and measured mean values were evaluated. Evaluation results were shown in the following Tables 5 to 9.

TABLE 5

| | Texture of lactic acid-fermented eggs at different | | | | | | | |
|---|---|---|---|---|---|---|---|---|
| | heat treatment temperatures* (heating time: 15 minutes) | | | | | | | |
| Item | 65° C. | 70° C. | 75° C. | 80° C. | 85° C. | 90° C. | 95° C. | 100° C. |
| Comparative | 8.7 | 8.5 | 8.2 | 8.0 | 6.0 | 5.5 | 4.2 | 3.5 |
| embodiment 1 | | | | | | | | |
| Embodiment 1 | 8.0 | 8.4 | 8.0 | 8.3 | 5.9 | 5.0 | 4.7 | 4.0 |

*Very good: 9, Good: 7, Average: 5, Poor: 3, Very poor: 1

The above Table 5 shows the evaluation result through an organoleptic test for texture of lactic acid-fermented eggs depending on heat treatment conditions and whether sodium citrate was added or not. When eggs were heat-treated at a temperature of 80° C. or lower, texture of lactic acid-fermented eggs was excellent, regardless of whether sodium citrate was added or not.

TABLE 6

| | Aroma of lactic acid-fermented eggs at different | | | | | | | |
|---|---|---|---|---|---|---|---|---|
| | heat treatment temperatures* (heating time: 15 minutes) | | | | | | | |
| Item | 65° C. | 70° C. | 75° C. | 80° C. | 85° C. | 90° C. | 95° C. | 100° C. |
| Comparative | 3.7 | 3.5 | 8.2 | 8.5 | 8.0 | 8.5 | 6.2 | 6.5 |
| embodiment 1 | | | | | | | | |
| Embodiment 1 | 3.0 | 3.4 | 8.0 | 8.3 | 8.9 | 8.2 | 6.7 | 6.0 |

*Very good: 9, Good: 7, Average: 5, Poor: 3, Very poor: 1

The above Table 6 shows the evaluation result through an organoleptic test for aroma of lactic acid-fermented eggs depending on heat treatment conditions and whether sodium citrate was added or not. When eggs were heat-treated at a temperature between 75° C. and 90° C., aroma of lactic acid-fermented eggs was excellent, regardless of whether sodium citrate was added or not.

TABLE 7

| | Color of lactic acid-fermented eggs at different | | | | | | | |
|---|---|---|---|---|---|---|---|---|
| | heat treatment temperatures* (heating time: 15 minutes) | | | | | | | |
| Item | 65° C. | 70° C. | 75° C. | 80° C. | 85° C. | 90° C. | 95° C. | 100° C. |
| Comparative | 8.5 | 8.2 | 8.1 | 8.3 | 8.0 | 8.0 | 8.2 | 7.5 |
| embodiment 1 | | | | | | | | |
| Embodiment 1 | 8.1 | 8.3 | 8.0 | 8.3 | 8.3 | 8.1 | 7.7 | 7.0 |

*Very good: 9, Good: 7, Average: 5, Poor: 3, Very poor: 1

The above Table 7 shows the evaluation result through an organoleptic test for color of lactic acid-fermented eggs depending on heat treatment conditions and whether sodium citrate was added or not. Color of lactic acid-fermented eggs was satisfactory overall, regardless of whether sodium citrate was added or not and heat treatment conditions. However, lactic acid-fermented eggs with heat treatment at 100° C. showed a somewhat dark color and were scored relatively lower than those with heat treatment at a temperature lower than 100° C.

TABLE 8

| | Taste of lactic acid-fermented eggs at different | | | | | | | |
|---|---|---|---|---|---|---|---|---|
| | heat treatment temperatures* (heating time: 15 minutes) | | | | | | | |
| Item | 65° C. | 70° C. | 75° C. | 80° C. | 85° C. | 90° C. | 95° C. | 100° C. |
| Comparative | 3.5 | 4.2 | 5.1 | 6.3 | 5.0 | 5.0 | 6.2 | 6.5 |
| embodiment 1 | | | | | | | | |
| Embodiment 1 | 3.1 | 5.3 | 8.4 | 8.3 | 8.2 | 8.0 | 5.7 | 6.0 |

*Very good: 9, Good: 7, Average: 5, Poor: 3, Very poor: 1

The above Table 8 shows the evaluation result through an organoleptic test for taste of lactic acid-fermented eggs depending on heat treatment conditions and whether sodium citrate was added or not. Taste of lactic acid-fermented eggs to which sodium citrate was added (Embodiment 1) was higher than that of lactic acid-fermented eggs to which sodium citrate was not added (Comparative embodiment 1), and especially, such effect was remarkable in the heat treatment temperature range between 75° C. and 90° C.

TABLE 9

| | Total preference of lactic acid-fermented eggs at different | | | | | | | |
|---|---|---|---|---|---|---|---|---|
| | heat treatment temperatures* (heating time: 15 minutes) | | | | | | | |
| Item | 65° C. | 70° C. | 75° C. | 80° C. | 85° C. | 90° C. | 95° C. | 100° C. |
| Comparative | 3.5 | 4.2 | 5.1 | 5.3 | 5.0 | 6.0 | 5.2 | 5.5 |
| embodiment 1 | | | | | | | | |
| Embodiment 1 | 3.1 | 5.3 | 8.3 | 8.5 | 5.3 | 6.1 | 5.7 | 5.0 |

*Very good: 9, Good: 7, Average: 5, Poor: 3, Very poor: 1

The above Table 9 shows the evaluation result through an organoleptic test for total preference of lactic acid-fermented eggs depending on heat treatment conditions and whether sodium citrate was added or not. Total preference of lactic acid-fermented eggs to which sodium citrate was added (Embodiment 1) was higher than that of lactic acid-fermented eggs to which sodium citrate was not added (Comparative embodiment 1), and especially, such effect was remarkable in the heat treatment temperature range between 75° C. and 80° C.

The present invention described above is not limited to the above embodiments and accompanying drawings, and it will be apparent to those skilled in the art that various substitutions, modifications and variations can be made therein without departing from the spirit and scope of the invention.

### Mode for Invention

20 eggs (size: extra large) were broken open and homogenized so as not to form too much foam, and were filtered through a 70 mesh sieve to obtain 1,000 g of chalazae removed, whole egg liquid. Egg mixture in which 1,700 g of purified water, g of glucose, 180 g of fructose, 55.2 g of fructooligosaccharide, and 4.5 g of sodium citrate were added to the whole egg liquid were prepared, heat-treated at 75° C. for 15 minutes, and were cooled immediately to 40° C. The egg mixture was inoculated with 0.3 g, that is, 0.01 weight % of a mixed lactic acid bacteria starter on the basis of a weight of the egg mixture, and the mixed lactic acid bacteria starter comprised 25% of Lactobacillus acidophilus, 25% of Lactobacillus bulgaricus, 25% of Bifidobacterium longum, and 25% of Streptococcus thermophiles. The egg mixture was incubated in a pyrostat at 40° C. for 6 hours for lactic acid fermentation, and was cooled immediately to be 4° C. or lower to prepare 3,000 g of lactic acid-fermented eggs having significantly reduced egg protein antigenicity. ciELISA test results showed that the antigenicity of ovomucoid (OM) of such produced lactic acid-fermented eggs was reduced to 1/52,500 or less, and the antigenicity of ovalbumin (OV) was reduced to 1/7,400 or less, compared to fresh eggs, and the lactic acid-fermented eggs were evaluated to be lactic acid-fermented egg beverages having reduced allergy, excellent solubility, and satisfactory organoleptic quality.

### INDUSTRIAL APPLICABILITY

Lactic acid-fermented egg beverages produced by the present invention are yogurt-type products having reduced egg allergy components and improved organoleptic quality, and can be used industrially as follows. First, egg lactic acid bacteria beverage products in which antigenicity of ovomucoid and ovalbumin being allergens of the most frequent food allergy (42%), that is, egg allergy, is reduced by lactic acid fermentation can be commercially available. Second, yogurt-type egg lactic acid bacteria beverage products which have improved organoleptic quality by removing unpleasant odor of eggs through lactic acid fermentation process and addition of specific salts, and contain one hundred million or more of living lactic acid bacteria per gram, and thus, are beneficial for intestinal health can be commercialized. Third, various egg yogurt products, including drinking type yogurts, stirred type yogurts, and so on, can be produced with the development of original technology for yogurt-type egg lactic acid fermentation products, and thus, the yogurt market is expected to be able to expand. Fourth, higher value added, various functional yogurts, such as omega-3 egg yogurts, gastritis preventive anti-helicobacter pylori IgY-containing egg yogurts, enteritis preventive IgY-containing egg yogurts, acne preventive IgY-containing egg yogurts, and the like, can be produced.

The present inventor has found ways for people who hates to eat eggs due to unpleasant odor or cannot eat eggs due to egg allergy to eat the most nutritious food, eggs, effectively, and reduced egg allergens through a lactic acid fermentation technology and removed the unpleasant egg odor with the addition of adequate sugars and salts, and finally, completed products, through which egg nourishment and lactic acid bacteria can be taken at the same time as beverages. Particularly, eggs are the only food that contains a full range of nutrients required for creating one life, chick, compared to yogurts made from cow milk, and eggs contain large amounts of phosphatidylcholine, cyanocobalamin, sialic acid, hyaluronic acid, and the like, which are known to have excellent effects on child's brain development and senile dementia prevention and are not contained in cow milk, and thus, the present product, in which eggs are the main component, is expected to be in high demand particularly in children and the elderly group. The present product is also expected to be an alternative to provide lactic acid bacteria, which are beneficial for intestinal health, effectively in a food type for consumers having symptoms of cow milk yogurt allergy.

Expected effectiveness caused by commercialization of the present product is as follows. First, due to hygienic production into beverages made from eggs, reluctance to consume eggs, upon the occurrence of AI virus infection, which is very common domestically, is expected to be prevented fundamentally. Since the egg yogurt passes through a high temperature sterilization process over thermal death point of viruses, consumers can be free from the danger of AI virus. Second, domestic poultry farming industry is expected to be activated. For the present product, in which eggs are the main component, the most important factor in determining product's quality may be egg freshness. Since it is practically difficult to use imported dried eggs or frozen eggs as raw materials, demand for domestic eggs is expected to increase steadily, and domestic poultry farming industry is expected to naturally accompany development in domestic poultry farming industry to ensure a stable supply of raw materials.

1. A method for preparing a lactic acid-fermented egg having reduced egg protein antigenicity, comprising:
adding and mixing 100 to 200 parts by weight of purified water, 25 to 35 parts by weight of sugars, and 0.4 to 0.5 parts by weight of sodium citrate, with respect to 100 parts by weight of homogenized and filtered whole egg liquid;
heat-treating the above mixture at a temperature between 75 and 80° C. for 10 to 20 minutes; and
inoculating the mixture with 0.0001 to 0.01 weight % of lactic acid bacteria on the basis of a weight of the mixture and fermenting the inoculated mixture at a temperature between 38 and 42° C. for 5 to 7 hours.

2. The method of claim 1, wherein the sugars comprises glucose, fructose, and fructooligosaccharide.

3. The method of claim 1, wherein the sugars comprises 5 to 8 parts by weight of glucose, 15 to 20 parts by weight of fructose, and 5 to 7 parts by weight of fructooligosaccharide.

4. The method of claim 1, wherein the lactic acid bacteria are a mixture of lactic acid bacteria comprising Lactobacillus acidophilus, Lactobacillus bulgaricus, Bifidobacterium longum, and Streptococcus thermophilus.

5. The method of claim 1, wherein the lactic acid bacteria are a mixture of lactic acid bacteria comprising 20 to 30 weight % of Lactobacillus acidophilus, 20 to 30 weight % of Lactobacillus bulgaricus, 20 to 30 weight % of Bifidobacterium longum, and 20 to 30 weight % of Streptococcus thermophilus.

6. A lactic acid-fermented egg having reduced egg protein antigenicity, prepared by the method of claim 1.

7. A lactic acid-fermented egg having reduced egg protein antigenicity, prepared by the method of claim 2.

8. A lactic acid-fermented egg having reduced egg protein antigenicity, prepared by the method of claim 3.

9. A lactic acid-fermented egg having reduced egg protein antigenicity, prepared by the method of claim 4.

10. A lactic acid-fermented egg having reduced egg protein antigenicity, prepared by the method of claim 5.
